(19) United States
(12) Patent Application Publication
(10) Pub. No.: US 2016/0001662 A1
(43) Pub. Date: Jan. 7, 2016

(54) BUFFERING ENERGY STORAGE SYSTEMS FOR REDUCED GRID AND VEHICLE BATTERY STRESS FOR IN-MOTION WIRELESS POWER TRANSFER SYSTEMS

(71) Applicant: UT-BATTELLE, LLC, Oak Ridge, TN (US)

(72) Inventors: John M. MILLER, Oak Ridge, TN (US); Omer C. ONAR, Oak Ridge, TN (US)

(21) Appl. No.: 14/768,340

(22) PCT Filed: Feb. 25, 2013
(86) PCT No.: PCT/US2013/027578

§ 371 Date: Aug. 17, 2015

(51) Int. Cl. B60L 11/18; H02J 5/00

(52) U.S. Cl. CPC B60L 11/182; H02J 5/005

(57) ABSTRACT

An energy buffer including an electrochemical capacitor can be added to the primary circuit and/or to the secondary circuit of in-motion wireless power transfer system. The energy buffer(s) can smoothen the power delivered by the power grid and captured by a vehicle passing over an array of transmit coils through in-motion wireless power transfer. The reduction in the transient power transfer can reduce the peak current that flows through various components of the in-motion wireless power transfer system including a vehicle battery on the vehicle, and prolong the life of the in-motion wireless power transfer system.

### STATEMENT REGARDING FEDERALLY SPONSORED RESEARCH OR DEVELOPMENT

This invention was made with government support under Contract No. DE-AC05-00OR22725 awarded by the U.S. Department of Energy. The government has certain rights in the invention.

### FIELD OF THE INVENTION

The present invention relates to the field of wireless power transfer, and particularly to in-motion wireless power transfer systems for use in charging plug-in electric vehicles, and methods of operating the same.

### BACKGROUND OF THE INVENTION

Plug-in Electric Vehicles (PEV) utilize a battery to store energy and power an electric motor to provide propulsion. When the battery becomes depleted, a PEV must be recharged for a period of time. Recharging may be performed by plugging the vehicle into an outlet or wirelessly with a primary and secondary coil. Wireless power transfer (WPT) charging has the benefit of being effortless and is the only option for in-motion vehicle charging.

Examples of wireless power transfer devices are described in: U.S. Patent Application Publication No. 2012/0043930 A1 published on Feb. 12, 2012 and issued as U.S. Pat. No. 8,310,202 on Nov. 13, 2012, and U.S. Provisional Patent Application Ser. Nos. 61/510,231, filed July 21, 2011; 61/510,210, filed Jul. 21, 2011; 61/510,206, filed Jul. 21, 2011; and 61/532,763, filed Sep. 9, 2011, each of which are incorporated herein by reference. Further, U.S. patent application Ser. No. 13/484,404 titled “REGULATION CONTROL AND ENERGY MANAGEMENT SCHEME FOR WIRELESS POWER TRANSFER” and filed on May 31, 2012 and U.S. patent application Ser. No. 13/739,198 titled “WIRELESS POWER CHARGING USING POINT OF LOAD CONTROLLED HIGH FREQUENCY POWER CONVERTERS” and filed on Jan. 11, 2013 are incorporated herein by reference.

Referring to FIGS. 1 and 2, operational principles of a wireless power transfer system according to an embodiment of the present disclosure are illustrated. The illustrated WPT system includes a charging station, a vehicle, and an optional gateway system, and an optional computing means in communication with the gateway system. The charging station includes the primary circuit, which includes the grid converter, the primary coil, and at least one primary capacitor in a series connection with a corresponding primary capacitor (Cᵣ₁ or Cᵣ₂). The vehicle includes the secondary circuit, which includes the secondary coil (i.e., a receiver coil), a receiver capacitor C_{R}, the current rectification circuit, a wireless charge control unit, and a high voltage (HV) battery. The total impedance of the current rectification circuit, the wireless charge control unit, and the HV battery as seen by the combination of the secondary coil and a parallel tuning capacitor of the secondary circuit is herein referred to as the load of the secondary circuit.

The primary circuit includes a grid converter and a primary coil located in a primary pad. The secondary circuit is located in the vehicle and includes a secondary coil, a parallel tuning capacitor, a current rectification circuit connected to the secondary coil, and a battery connected to the current rectification circuit. The primary coil may include a single transmit coil or a plurality of transmit coils located at different pad locations as illustrated in FIG. 2. The vehicle further includes a battery management system configured to measure at least one parameter of the battery, and a vehicle-side communication means configured to transmit information on the at least one parameter of the battery. The at least one parameter is a measure of an effective resistance of the battery as seen by the primary circuit. The charging station can further include an output voltage controller configured to control an alternating current (AC) output voltage of the grid converter based on information derived from the at least one parameter of the battery.

Optionally, a gateway system can be provided. The gateway system can be configured to receive information on the at least one parameter of the battery as transmitted by the vehicle-side communication means, and can be configured to transmit the information derived from the at least one parameter, directly or indirectly, to the output voltage controller. In one embodiment, the gateway system can employ internet.

Optionally, a grid-side communication means can be provided. The grid-side communication means can be configured to receive the information derived from the at least one parameter, and can be configured to relay the information derived from the at least one parameter to the output voltage controller.

Alternately or additionally, direct short range communication (DSRC) can be employed to provide feedback on the battery voltage U_{b}, the battery current I_{b}, battery management system (BMS) messages, faults, sensor inputs, and status between the vehicle and the charging facility. The information can be employed to control the switching frequency and duty cycle control in the primary circuit and to provide power factor (PF) compensation.

Most in-motion wireless power transfer systems are expected to be installed on high ways as shown in FIG. 3. In such a system, when the vehicles are traveling through the wireless power transfer pads, the power delivered from the grid and power received by the vehicle battery should be very high so that a reasonable amount of energy can be transferred to the vehicle. However, this high power transfer in a very short period of time adds a considerable fast transient loading to the grid. In addition, the vehicle battery receives a pulse of high power in a very short period of time. This grid or battery stress can typically be interpreted as a high current ripple on the grid and the battery. This fast transient on the grid current may trip the power system protection circuit and may add a burden on the power system transformers as well as the power lines. On the battery side, this high current may cause a shortened battery lifetime since batteries are more likely to last longer if they are cycled with smooth currents free of any transients or high current peaks. In other words, a battery which is subjected to charge cycles with high charging rates may have a relatively shorter lifetime.

### SUMMARY OF THE INVENTION

An energy buffer including an electrochemical capacitor can be added to the primary circuit and/or to the secondary circuit of in-motion wireless power transfer system. The energy buffer(s) can smooth the power delivered by the power grid and captured by a vehicle passing over an array of transmit coils through in-motion wireless power transfer. The reduction in the transient power transfer can reduce the peak current that flows through various components of the in-motion wireless power transfer system including a vehicle battery on the vehicle, and prolong the life of the in-motion wireless power transfer system.

The energy buffer employs a fast response electrochemical energy storage system employing an electrochemical capacitor, which can be installed on the grid (transmit) side and/or the battery (receiver) side of the wireless power transfer system. Electrochemical capacitors have extremely high power densities, can handle extremely high currents, have very low internal resistances, and have very high cycling efficiencies. Therefore, by utilizing the ultra-capacitors, it can be provided that vehicle battery is not subject to receive peak and sharp power variations, the stress on the battery can be reduced, and prolonged battery lifetime can be achieved.

According to an aspect of the present disclosure, a receiver circuit for wireless power transfer is provided. The receiver circuit includes a receiver coil and a receiver capacitor connected to the receiver coil; a rectifier circuit configured to receive a voltage across the receiver capacitor as an input and to generate an output voltage including a direct current component and an alternating current (AC) ripple component; an electrochemical capacitor directly or indirectly connected to the output voltage; and a vehicle battery directly or indirectly connected to the output voltage.

According to another aspect of the present disclosure, a method of operating a receiver circuit for wireless power transfer in an electric vehicle is provided. The method includes providing a vehicle equipped with a receiver circuit that includes a receiver coil and a receiver capacitor connected to the receiver coil; a rectifier circuit configured to receive a voltage across the receiver capacitor as an input and to generate an output voltage including a direct current component and an alternating current (AC) ripple component; an electrochemical capacitor directly or indirectly connected to the output voltage; and a vehicle battery directly or indirectly connected to the output voltage. The method further includes the steps of: causing the vehicle to pass over a track of transmit pads including transmit coils and storing energy received from the transmit coils through wireless power transfer in the electrochemical capacitor; and transferring energy stored in the electrochemical capacitor into the vehicle battery after the vehicle exits a region overlying the track of transmit pads.

According to yet another aspect of the present disclosure, a transmitter circuit for wireless power transfer is provided. The transmitter circuit includes an active front end (AFE) unit including input nodes configured to be connected to alternating current (AC) power from a power grid and output nodes configured to provide a unipolar output voltage; a high frequency inverter configured to convert the unipolar output voltage or a direct current (DC) voltage derived from the unipolar output voltage into an AC output voltage in a frequency range from 1 kHz to 1 MHz; at least one set of a primary coil and a primary capacitor connected to the high frequency inverter; and an electrochemical capacitor connected to nodes between the power grid and the high frequency inverter.

According to still another aspect of the present disclosure, a method of operating a transmitter circuit for wireless power transfer is provided. The method includes providing a transmitter circuit that includes an active front end (AFE) unit including input nodes configured to be connected to alternating current (AC) power from a power grid and output nodes configured to provide a unipolar output voltage; a high frequency inverter configured to convert the unipolar output voltage or a direct current (DC) voltage derived from the unipolar output voltage into an AC output voltage in a frequency range from 1 kHz to 1 MHz; at least one set of a primary coil and a primary capacitor connected to the high frequency inverter; and an electrochemical capacitor connected to nodes between the power grid and the high frequency inverter. The at least one primary coil is located within a track of at least one transmit pad. The method further includes the steps of storing energy in said electrochemical capacitor while the at least one primary coil does not perform wireless power transfer; and transferring energy stored in the electrochemical capacitor into the high frequency inverter while wireless power transfer is performed from the at least one primary coil to an electric vehicle passing over the track of at least one transmit pad.

### BRIEF DESCRIPTION OF THE DRAWINGS

FIG. 1 is a diagram illustrating operational principles of wireless power transfer systems.

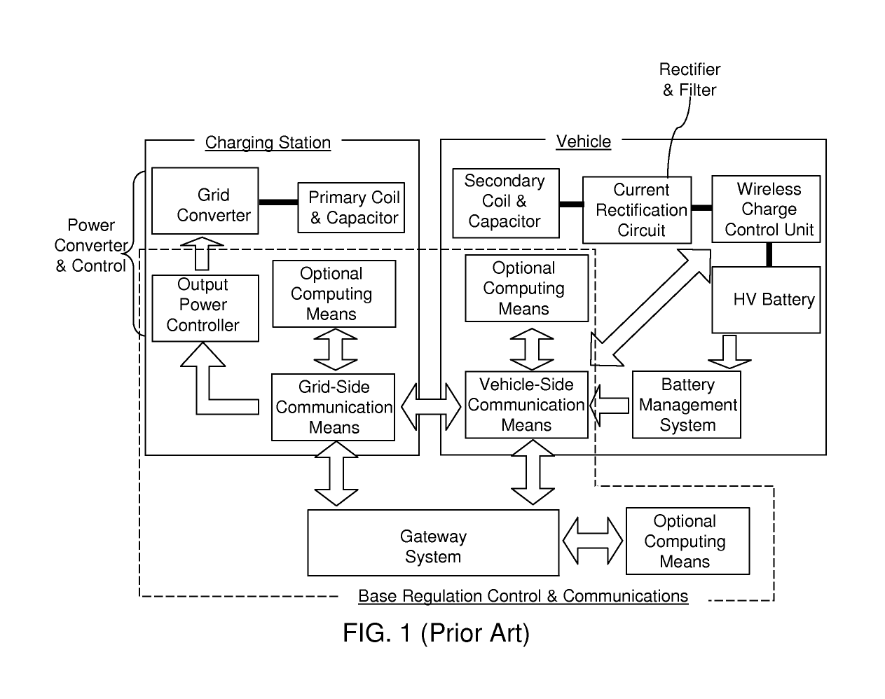

FIG. 2 is a system level diagram of an in-motion wireless power transfer system.

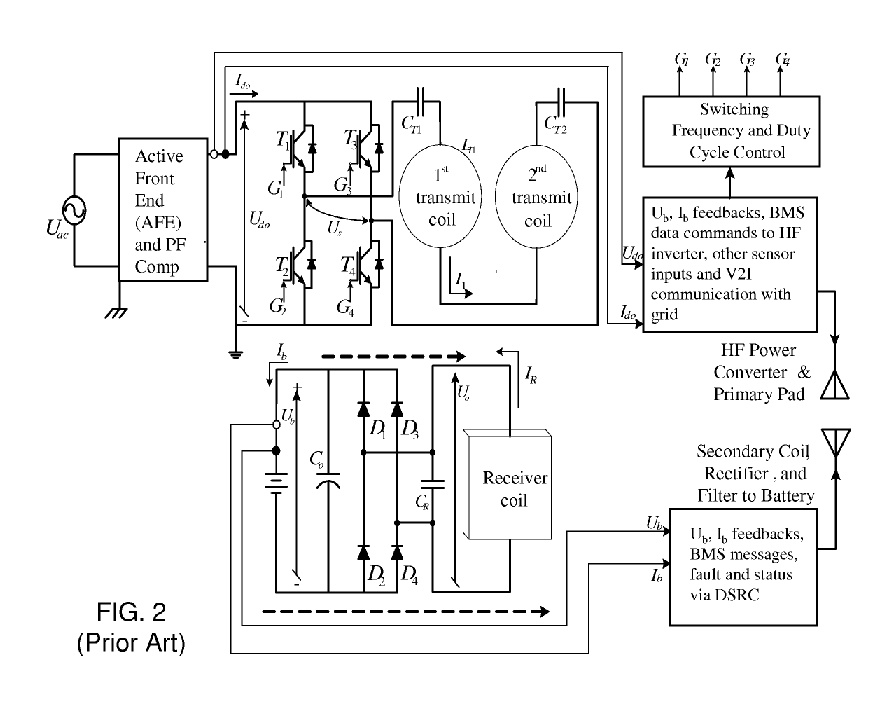

FIG. 3 is a photo of an electric vehicle that is passing over wireless transmit coils on a highway.

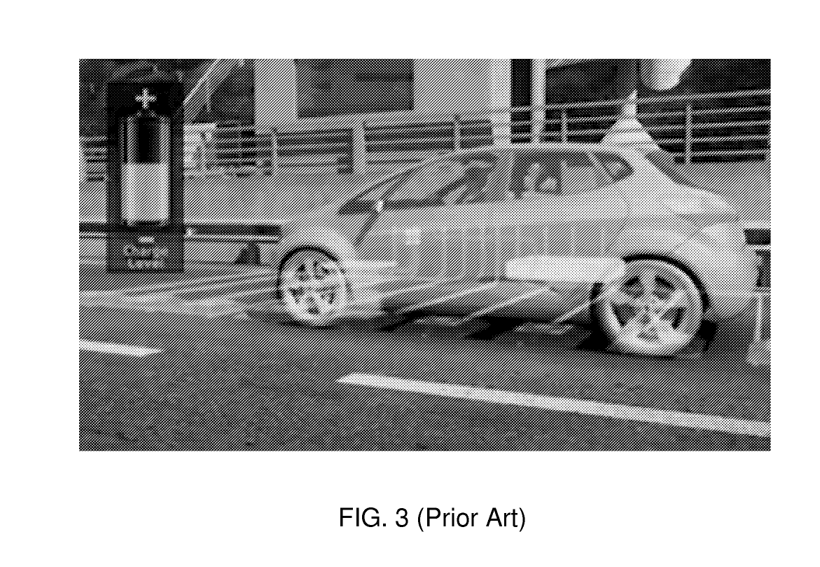

FIG. 4 is a schematic view of an exemplary grid side circuitry and a vehicular side circuitry of an exemplary wireless power transfer system according to an embodiment of the present disclosure.

FIG. 5 is a schematic view of a grid side circuit including a connection between a power grid and an electrochemical capacitor through a ripple-magnifying bidirectional rectifier/inverter according to an embodiment of the present disclosure.

FIG. 5A is a schematic view of the circuit of FIG. 5 in which components of the ripple-magnifying bidirectional rectifier/inverter are shown in detail.

FIG. 6 is a schematic view of a grid side circuit including a direct current (DC) link connection to an electrochemical capacitor through a ripple-magnifying bidirectional rectifier/inverter according to an embodiment of the present disclosure.

FIG. 7 is a schematic view of a grid side circuit including a passive parallel connection to an electrochemical capacitor according to an embodiment of the present disclosure.

FIG. 8 is a schematic view of a grid side circuit including a cascaded connection of an electrochemical capacitor and a bidirectional rectifier/inverter according to an embodiment of the present disclosure.

FIG. 9 is a schematic view of a vehicle side circuit including a cascaded connection of an electrochemical capacitor and a bidirectional rectifier/inverter according to an embodiment of the present disclosure.

FIG. 10 is a schematic view of a vehicle side circuit including a cascaded connection of a ripple-magnifying DC-DC converter, an electrochemical capacitor and a ripple-reducing bidirectional rectifier/inverter according to an embodiment of the present disclosure.

FIG. 11 is a schematic view of a vehicle side circuit including a direct link connection a battery of a combination of a ripple-magnifying bidirectional rectifier/inverter and an electrochemical capacitor between a bridge rectifier and a battery according to an embodiment of the present disclosure.

FIG. 11A is a schematic view of the circuit of FIG. 11 in which components of the ripple-magnifying bidirectional rectifier/inverter are shown in detail.

FIG. 12 is a schematic view of a vehicle side circuit including a direct link connection a battery of a combination of a ripple-magnifying bidirectional rectifier/inverter and an electrochemical capacitor between a bridge rectifier and a ripple-reducing bidirectional rectifier/inverter according to an embodiment of the present disclosure.

FIG. 13A is a picture of a laboratory test setup for the in-motion wireless power transfer system including six coils embedded within the platform roadway according to an embodiment of the present disclosure.

FIG. 13B is a picture of a laboratory test setup for the in-motion wireless power transfer system including an electric vehicle with a receiver coil passing through the transmit coils within the platform roadway according to an embodiment of the present disclosure.

FIG. 14 is a tabulated diagram illustrating relative positions of the receiver coil with respect to first two of the six transmit coils according to an embodiment of the present disclosure.

FIG. 15 is a graph illustrating the power delivered from the grid as a function of the position during in-motion wireless power transfer according to an embodiment of the present disclosure.

FIG. 16 is a graph illustrating the power received by the vehicle battery as a function of the position during in-motion wireless power transfer according to an embodiment of the present disclosure.

### DETAILED DESCRIPTION OF THE INVENTION

As stated above, the present invention relates to stationary and dynamic wireless power chargers for use in charging plug-in electric vehicles, and methods of operating the same, which is now described in detail with accompanying figures. The drawings are not drawn to scale.

As used herein, “wireless power transfer” or “WPT” refers to the transmission of electrical energy from a power source to an electrical load through an inductive coupling between a primary coil and a secondary coil.

As used herein, a “grid converter” herein refers to a device that takes alternating current (AC) supply voltage having a frequency less than 1 kHz and generated alternating current (AC) supply voltage having a frequency greater than 1 kHz.

As used herein, an “electrochemical capacitor” refers to any capacitor selected from a class of capacitors that includes electric double-layer capacitors, electric multi-layer capacitors, ultracapacitors, supercapacitors, lithium-ion capacitors (LiC), lead acid battery capacitors, ultrabatteries that integrate a lead acid battery capacitor with a supercapcitor, and other equivalent actively or passively controlled energy storage systems that can provide fast response within a time scale of microseconds as known in the art currently or in the future. An electrochemical capacitor as referred herein can be a single electrochemical capacitor or a plurality of electrochemical capacitors in a parallel connection and/or in a series connection.

As used herein, an “active front end unit” or an “AFE unit” refers to a unit including a grid converter and optionally configured to provide power factor compensation control to minimize power loss during wireless power transfer.

As used herein, a ‘DC-DC” converter is a converter that uses a unipolar voltage as an input and generates DC power as an output. The power input may include alternating current (AC) ripples having a magnitude less than ½ of the magnitude of the DC component.

As used herein, a “unipolar” voltage refers to a voltage of which the polarity does not change as a function of time.

An electrochemical capacitor can be added to the grid side circuit (transmitter circuit) and/or the vehicle side circuit (receiver circuit) to smoothen the power delivered by the power grid and captured by the vehicle for in-motion (dynamic) wireless power transfer. The electrochemical capacitors reduce the battery and grid power peaks by providing a fast response to temporarily store energies provided by transient signals.

Wireless charging of plug-in vehicles (PEV's) is already attractive to customers because of convenience, safety and flexibility. Wireless charging is convenient because of no need for cable and plug connections. Wireless power transfer (WPT) systems are safe because there is inherently no leakage current between the vehicle and the earth due to the charging function. Wireless charging provides flexibility because the on-board charging system makes dual use of an on-board-charger (OBC).

For wireless in-motion charging systems, high battery current ripples and high stress on the grid current may cause a technical challenge or barrier in commercialization of this technology. The missing piece to the wireless in-motion power transfer system is the capability to supply/deliver high power without putting additional stressing neither to the power grid nor to the vehicle battery. The present disclosure provides such a capability to deliver high power without causing stress to the power grid or to the vehicle battery. The present disclosure provides a fully autonomous means of smoothing the grid current and battery current with the aid of a fast-response electrochemical capacitor based energy storage system.

Smoothing the grid current makes economical sense since it helps avoid tripping the protection equipment and eliminates potential outages to the additional burden that may be introduced by the pulsating high power demanded by the wireless power transfer system. From the traction battery perspective, wireless power transfer system already introduces reduced size battery packs since the vehicles can be recharged as they are driven. Addition of a fast response electrochemical capacitor ensures that the battery current ripples can be eliminated and the vehicle battery can be recharged relatively slower by using the high burst of power received by the electrochemical capacitor in a short period of time. The present disclosure furthermore avoids any battery lifetime reductions that may be due to the high current ripples or relatively fast charging for a short period of time.

Employing fast response electrochemical capacitors based energy storage buffers have never been applied for wireless power transfer systems. Particularly for in-motion wireless applications, using electrochemical capacitor energy storage systems for the purpose of grid support or vehicle battery current ripple reduction can enable use of a high power capable buffer available for both transmit and receive sides of the system. Both transmitter side and the receiver side have component that are relatively sensitive to the fast transients or high current ripples.

The present disclosure provides various interconnection topologies for the electrochemical capacitor energy storage systems. Both the grid interaction methods and the hybridization configurations of electrochemical capacitor energy storage systems with the existing vehicle batteries are disclosed herein.

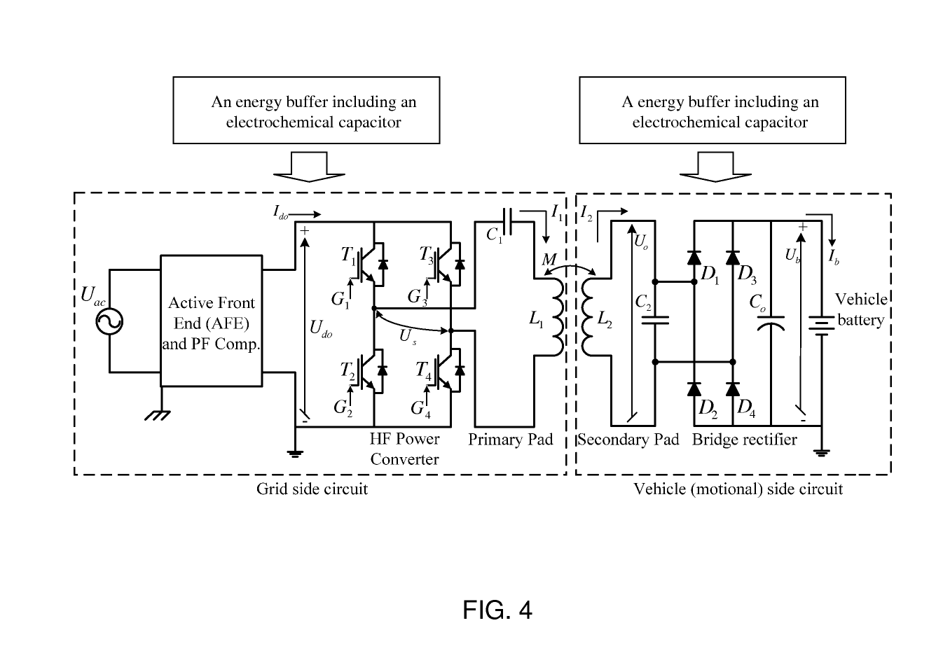

Referring to FIG. 4, an exemplary grid side circuitry (transmitter circuitry) and a vehicular side circuitry (receiver circuitry) of an exemplary wireless power transfer system are shown. An electrochemical capacitor energy buffer can be connected to the grid side circuitry and/or to the vehicle side circuitry of the wireless power transfer system.

In order to make the grid current smoother, an electrochemical capacitor can be interfaced to the grid side before, or after, an active front end unit (AFE unit). The AFE unit is a rectifier and power factor compensator (represented as “Active Front End (AFE) and PF Comp” in FIG. 4.

The grid side circuit includes an active front end (AFE) unit, a high frequency power converter, and a series connection of a transmit capacitor (primary capacitor) and a transmit coil (primary coil) located in each transmit pad (primary pad). The vehicle includes a high frequency receiver coil (which is a secondary coil), a rectifier and filter circuit, and a vehicle battery.

The AFE unit, i.e., an AFE converter, is connected to a utility power supply, and provides power factor correction. The AFE unit generates a unipolar output voltage U_{do}, which has the same polarity relative to electrical ground during the operation of the AFE unit. For example, the unipolar output voltage may be non-negative (positive or zero) at all times, or non-positive (negative or zero) at all times.

The AFE unit may include only passive rectification devices (such as diodes), or may include rectification devices with active electronic control. If the AFE unit includes rectification devices with active electronic control, the control signals may be provided by the output power controller. In one embodiment, the rectification devices with active electronic control may include thyristors configured to be controlled through input voltages. In one embodiment, additional electronic components such as capacitors may be provided to stabilize the unipolar output voltage U_{do}. Thus, the unipolar output voltage U_{do} may vary with twice the frequency of the grid power supply voltage U_{ac} (i.e., at 120 Hz), or may be substantially constant through voltage stabilizing electronic components (such as capacitors—not shown), or may have a substantially constant direct current (DC) component and a superposed ripple having twice the frequency of the grid power supply voltage U_{ac}.

Various transmitter circuits for wireless power transfer are provided according to embodiments of the present disclosure. The transmitter circuits of the present disclosure include an active front end (AFE) unit, a high frequency inverter, at least one set of a primary coil and a primary capacitor, and an electrochemical capacitor. The AFE unit includes input nodes configured to be connected to alternating current (AC) power from a power grid and output nodes configured to provide a unipolar output voltage. The high frequency inverter is configured to convert the unipolar output voltage or a direct current (DC) voltage derived from the unipolar output voltage into an AC output voltage. In one embodiment, the AC output voltage can be in a frequency range from 1 kHz to 1 MHz, although lesser and greater frequencies can also be employed. Each of the at least one set of a primary coil and a primary capacitor can be connected to the high frequency inverter. The electrochemical capacitor is connected to nodes between the power grid and the high frequency inverter.

The various transmitter circuits of the present disclosure can be operated in the following manner. A transmitter circuit of the present disclosure can be provided such that the at least one primary coil is located within a track of at least one transmit pad. Energy can be stored in the electrochemical capacitor while the at least one primary coil does not perform wireless power transfer. The energy stored in the electrochemical capacitor can be transferred into the high frequency inverter while wireless power transfer is performed from the at least one primary coil to an electric vehicle passing over the track of at least one transmit pad.

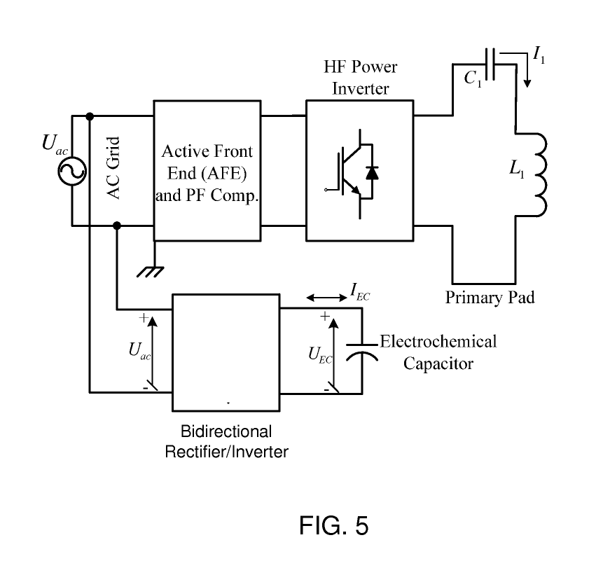

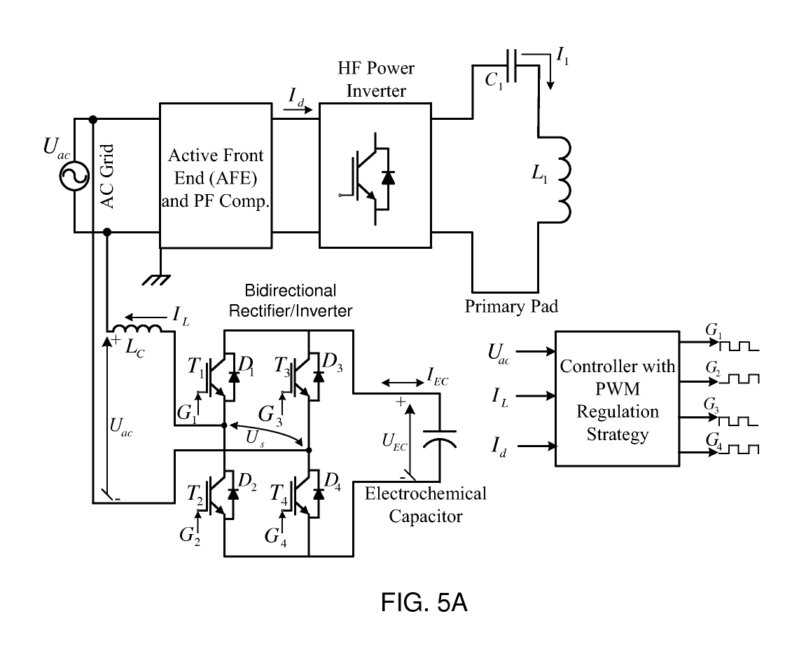

Referring to FIG. 5, a first exemplary transmitter circuit for wireless power transfer is shown, in which an electrochemical capacitor energy storage system including the electrochemical capacitor is connected to an alternating current (AC) power grid through a bidirectional inverter/rectifier. FIG. 5A is another view of the first exemplary transmitter circuit in which components of the electrochemical capacitor energy storage system are shown.

A bidirectional rectifier/inverter includes first nodes connected directly to the input nodes of the AFE unit and second nodes connected directly across nodes of the electrochemical capacitor. As used herein, a rectifier/inverter refers to a device configured to operate as a rectifier in one mode, and as an inverter in another mode. In this embodiment, the bidirectional rectifier/inverter is configured to operate as a rectifier employing the first nodes as input nodes and employing the first nodes as output nodes while the at least one set is not loaded with electrical current. Further, the bidirectional rectifier/inverter is configured to operate as an inverter employing the second nodes as input nodes and employing the first nodes as output nodes while the at least one set is loaded with electrical current. During the operation of the first exemplary transmitter circuit, the bidirectional rectifier/inverter can be operated as a rectifier employing the first nodes as input nodes and employing the first nodes as output nodes while the at least one primary coil does not perform wireless power transfer, and the bidirectional rectifier/inverter can be operated as an inverter employing the second nodes as input nodes and employing the first nodes as output nodes while the at least one primary coil performs wireless power transfer.

The electrochemical capacitor energy storage system of the present disclosure can be a single electrochemical capacitor, or can be a series connection of a plurality of electrochemical capacitors, or can be parallel connection of a plurality of electrochemical capacitors, or can be a combination of at least one series connection and at least one parallel connection of electrochemical capacitors. While the term “electrochemical capacitor” is employed to describe the present invention, it is understood that the electrochemical capacitor refers to an electrochemical capacitor energy storage system that can include one or more electrochemical capacitors in (a) parallel connection(s) and/or (a) series connection(s).

The electrochemical capacitor of the present disclosure can have a capacitance grater than 1 Farad. In one embodiment, the electrochemical capacitor of the present disclosure can have a capacitance greater than 10 Farad. In another embodiment, the electrochemical capacitor of the present disclosure can have a capacitance greater than 50 Farad. In yet another embodiment, the electrochemical capacitor of the present disclosure can have a capacitance in a range from 100 Farad to 10,000 Farad, although lesser and greater capacitances can also be employed.

In the grid side electrochemical capacitor interconnection scheme illustrated in FIGS. 5 and 5A, a bidirectional converter capable of a dual mode operation is attached to the output nodes of a power grid, which are the input nodes of the active front end (AFE) unit including a grid converter. The bidirectional mode is capable of operation in a rectifier mode (or a “forward mode”) in which the AC power from the grid charges the electrochemical capacitor, and operation in an inverter mode (i.e., a “reverse mode”) in which the stored power in the electrochemical capacitor is released to at least partially power the AFE unit. During the operation of the WPT system, a bidirectional converter is first controlled in the rectifier mode to smoothly charge the electrochemical capacitor. The operation in the rectifier mode is stopped when the electrochemical capacitor voltage reaches to its target value. As a vehicle starts passing over the primary coil(s), the bidirectional converter is operated in the inverter mode. In this mode, the electrochemical capacitor is discharged with a high pulse power so that the charging power required for the passing car is not predominantly supplied from the power grid, but from the electrochemical capacitor. Once the vehicle moves away from the primary pads (transmit pads) including the primary coil(s), the bidirectional converter is again operated in the rectifier mode to recharge the electrochemical capacitor over a time scale that is longer than the time needed for a vehicle to pass over the primary pads.

In the rectifier mode, the internal diodes of the bidirectional rectifier/inverter function as actively controlled switches. For positive half-line cycle of the AC grid voltage, D₁ and D₄ turn on and D₂ and D₃ turn off, whereas for the negative half-line cycle of the AC grid voltage, D₂ and D₃ turn on and D₁ and D₄ turn off. Then, as soon as a vehicle starts passing through the primary coil, the bidirectional converter is operated in the inverter mode. In this mode, EC is discharged with a high pulse power so that the charging power required for the car is not supplied from the grid but it comes from the electrochemical capacitor through the bidirectional rectifier/inverter that functions as an inverter. In inverter mode, a sinusoidal pulse width modulation (PSM) switching control strategy can be used to control the pair of switches T₁ and T₄ and the pair of switches T₂ and T₃ to supply a sinusoidal current in phase with the grid voltage. This current from the electrochemical capacitor is supplied at a high magnitude for a short duration of time that accommodates the charging power of the vehicle.

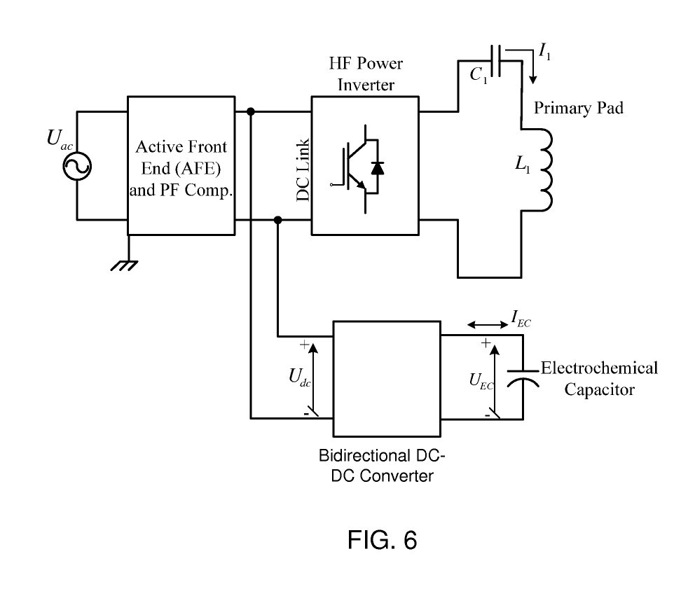

Referring to FIG. 6, a second exemplary transmitter circuit is illustrated, in which a bidirectional DC-DC converter including first nodes connected directly to nodes providing the unipolar output voltage and including second nodes connected directly across nodes of the electrochemical capacitor. The electrochemical energy storage system is an electrochemical capacitor that is connected to a direct current (DC) link between the output nodes of an AFE unit and input nodes of a high frequency inverter through a bidirectional DC-DC converter.

The high frequency inverter turns on and off a series of transistors such that output voltage of the high frequency inverter includes a fundamental mode of the output voltage at the operational frequency of the primary coil. In this configuration, a bidirectional DC-DC converter is utilized and the electrochemical capacitor is moved from the AC side to the DC side of the transmitter circuit (primary circuit) instead of using a bidirectional rectifier/inverter employed in FIGS. 5 and 5A. In this case, the electrochemical capacitor is recharged by the DC power transmitted from the DC link through the DC-DC converter under normal conditions. As soon as a vehicle starts passing over the primary pad(s), the energy in the electrochemical capacitor is discharged through the bidirectional DC-DC converter to the DC link. After vehicle exits the portion of the WPT charging track connected to the primary circuit (transmitter circuit), the DC-DC converter is again operated to recharge the electrochemical capacitor over a time scale that is longer than the time needed for a vehicle to pass over the primary pads. The bidirectional DC-DC converter can include at least one transistor configured to connect and disconnect the flow of DC current between the DC link and the electrochemical capacitor. The bidirectional DC-DC converter may be a switch that connects input nodes and output nodes without change of a voltage level, or may include a voltage-level-shifting circuitry such as a buck-boost circuitry.

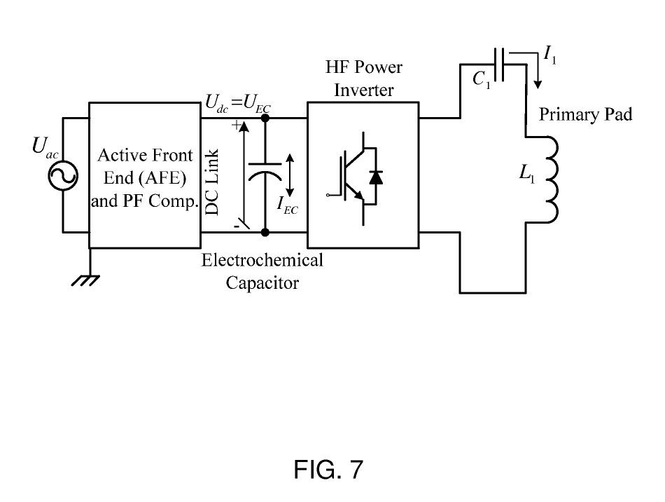

Referring to FIG. 7 a third exemplary transmitter circuit is shown, in which the electrochemical capacitor is connected directly across nodes providing the unipolar output voltage. The electrochemical capacitor energy storage system can be an electrochemical capacitor that is passively and directly connected to the DC link between the output nodes of an AFE unit and input nodes of a high frequency inverter through a parallel connection with the high frequency inverter. In this case, the electrochemical capacitor supplies a large burst of power to the high frequency inverter as a vehicle passes over the primary pad(s). Although this configuration does not provide an active energy management on the electrochemical capacitor as in the circuit of FIG. 6, the voltage dynamics of the output of the AFE unit, i.e., the DC link, can be slowed down so that the high charging power supplied to the passing vehicles does not reflect back to the power grid.

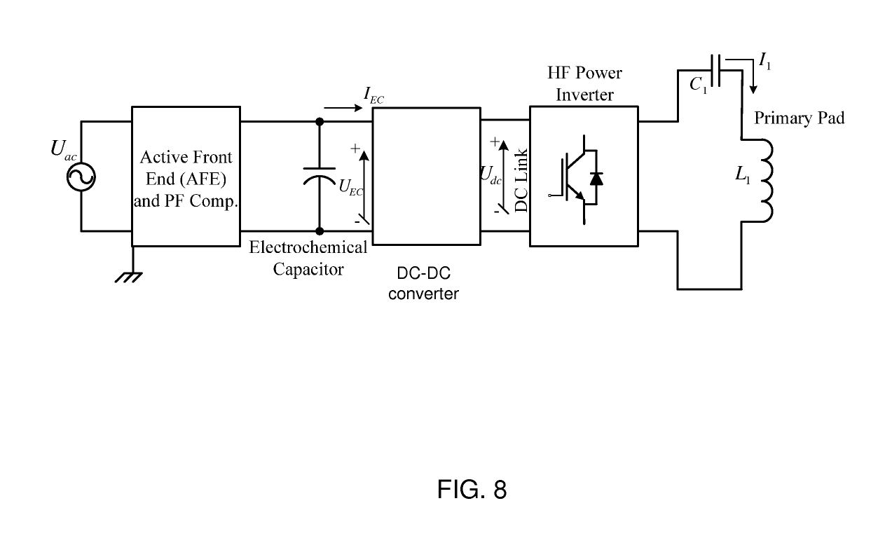

Referring to FIG. 8, a fourth exemplary transmitter circuit includes a DC-DC converter. The DC-DC converter includes input nodes that are connected directly across nodes providing the unipolar output voltage and directly across the electrochemical capacitor, and includes output nodes that are connected directly to the high frequency inverter. The energy stored in the electrochemical capacitor is transferred into the high frequency inverter though the DC-DC converter.

A combination of an electrochemical capacitor energy storage system and a cascaded DC-DC converter is inserted at the DC link between the output nodes of an AFE unit and input nodes of a high frequency inverter. In this case, the electrochemical capacitor and the DC-DC converter are in a cascaded configuration, and is located between the output nodes of the AFE unit and the input nodes of the high frequency inverter. In this scheme, the DC-DC converter may, or may not be, a bidirectional DC-DC converter. Thus, savings in cost and size are possible by employing a unidirectional DC-DC converter instead of a bidirectional DC-DC converter.

In addition to, or in lieu of, an electrochemical capacitor energy storage system that is added to the primary circuit (transmitter circuit), another electrochemical capacitor energy storage system can be added to a secondary circuit (receiver circuit) of a vehicle. Various configurations can be employed to provide vehicle side energy buffering with the aid of an electrochemical capacitor.

Various receiver circuits for wireless power transfer are provided according to embodiments of the present disclosure. The receiver circuits of the present disclosure include a receiver coil and a receiver capacitor connected to the receiver coil; a rectifier circuit configured to receive a voltage across the receiver capacitor as an input and to generate an output voltage including a direct current component and an alternating current (AC) ripple component; an electrochemical capacitor directly or indirectly connected to the output voltage; and a vehicle battery directly or indirectly connected to the output voltage.

The various receiver circuits of the present disclosure can be operated in the following manner. A vehicle equipped with a receiver circuit of the present disclosure is provided. The vehicle is caused to pass over a track of transmit pads including transmit coils and energy received from the transmit coils through wireless power transfer is stored in the electrochemical capacitor. The energy stored in the electrochemical capacitor is transferred into the vehicle battery after the vehicle exits a region overlying the track of transmit pads.

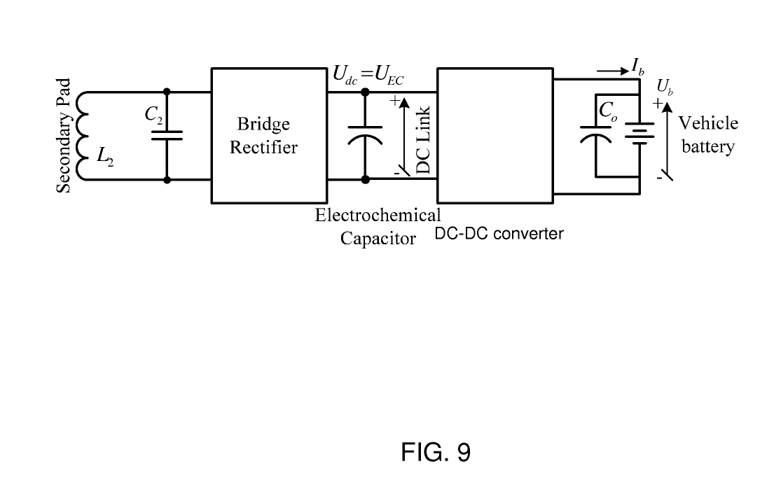

Referring to FIG. 9, a first exemplary receiver circuit is shown, in which an electrochemical capacitor energy storage system including the electrochemical capacitor is connected to the battery terminals via a cascaded DC-DC converter. The cascaded DC-DC converter has input nodes that are directly connected across the electrochemical capacitor and output nodes that are directly connected across nodes of the vehicle battery. The electrochemical capacitor is connected directly to the output voltage.

In this case, the high power pulse received by the secondary coils during passage of the vehicle over primary coils (transmitter coils) is rectified by the bridge rectifier, and is applied to the DC link. Due to a relatively high impedance of the electrochemical capacitor at the operational frequency of the WPT system compared to the impedance of the DC-DC converter, the electrochemical capacitor receives the high frequency charging pulses and stores electrical energy therein. When the vehicle completes its passage over WPT pad tracks, the discharge of energy from the electrochemical capacitor can be controlled by the DC-DC converter in such a way that enables slow recharging the battery over a period of time that is longer than the time it takes for the vehicle to pass over the WPT pad tracks.

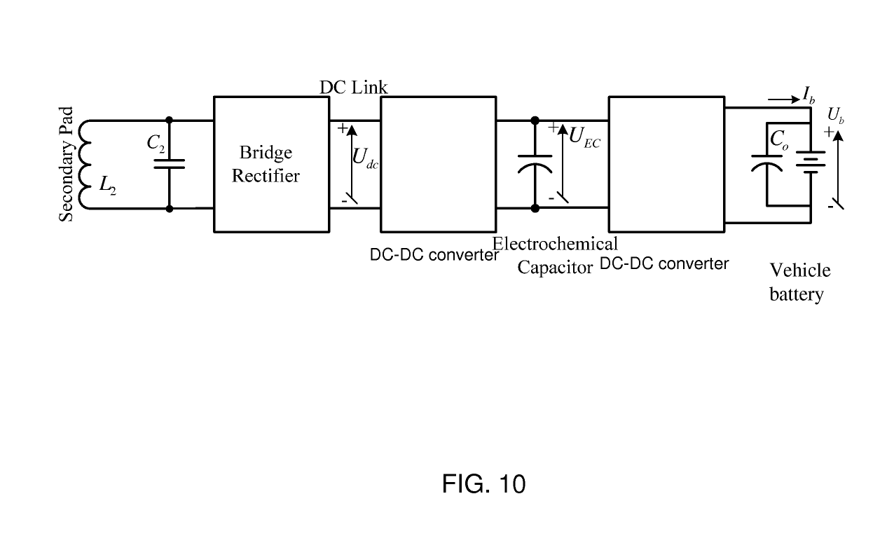

Referring to FIG. 10, a second exemplary receiver circuit is shown, in which an electrochemical capacitor energy storage system including the electrochemical capacitor is connected to the DC link at the output of a bridge rectifier through a first cascaded DC-DC converter, and is connected to battery terminals via a second cascaded DC-DC converter. The first cascaded DC-DC converter has input nodes that are directly connected across output nodes of the rectifier circuit and output nodes that are directly connected across nodes of the electrochemical capacitor. The second cascaded DC-DC converter has input nodes that are directly connected across the electrochemical capacitor and output nodes that are directly connected across nodes of the vehicle battery. This configuration may provide a more flexible control of the power stored in the electrochemical capacitor. In this configuration, the voltage across the electrochemical capacitor is decoupled from the DC link voltage, i.e., the output voltage from the bridge rectifier.

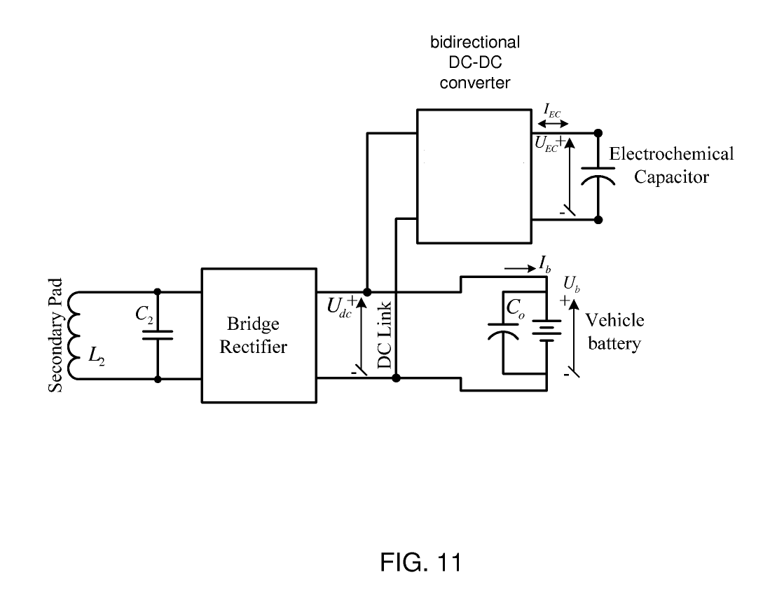

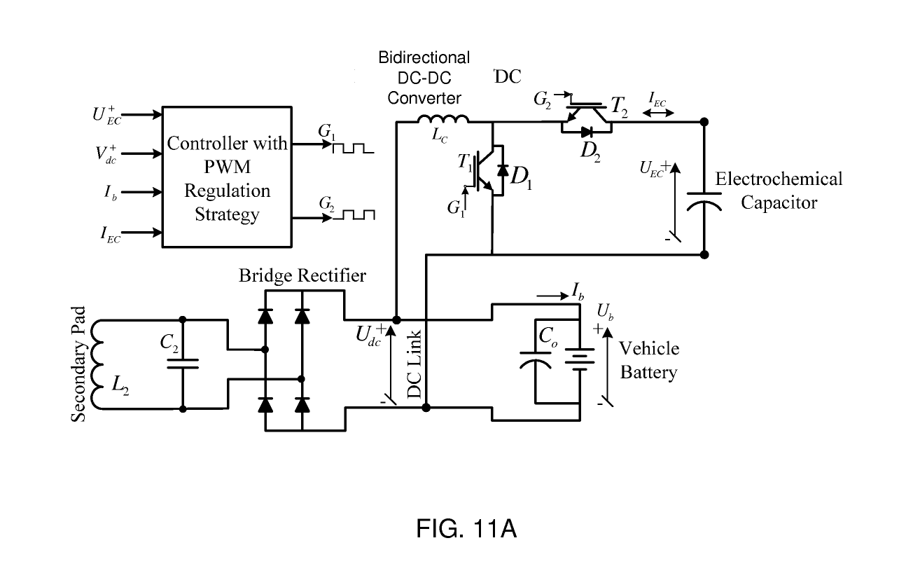

Referring to FIGS. 11 and 11A, a third exemplary receiver circuit is shown, which includes a bidirectional DC-DC converter connected between nodes of the output voltage of the rectifier circuit and nodes of the electrochemical capacitor. The electrochemical capacitor energy storage system including the electrochemical capacitor is connected to the DC link between the output of the bridge rectifier and battery terminals through a bidirectional DC-DC converter. The combination of the bidirectional DC-DC converter and the electrochemical capacitor is in parallel connection with the vehicle battery with respect to the output of the bridge rectifier. The bidirectional DC-DC converter can be, for example, a bidirectional buck-boost DC-DC converter. The combination of the bidirectional DC-DC converter and the electrochemical capacitor is in parallel connection with the vehicle battery with respect to an output of the rectifier circuit.

During operation of the third exemplary receiver circuit, energy is transferred from the rectifier circuit through the bidirectional DC-DC converter into the electrochemical capacitor while the vehicle passes over the track of transmit pads, which causes the series connection of the transmit coil and the primary capacitor to be loaded with electrical current. Further, energy is transferred from the electrochemical capacitor through the bidirectional DC-DC converter into the vehicle battery after the vehicle exits the region overlying the track of transmit pads, which causes the series connection of the transmit coil and the primary capacitor not to be loaded with electrical current. Thus, the electrochemical capacitor is charged with a high power pulse when the vehicle moves over WPT pads. Once the electrical charges accumulate in the electrochemical capacitor and the vehicle moves away from the WPT pads, the bidirectional DC-DC converter controls the discharge of the electrochemical capacitor so as to slowly recharge the vehicle battery over a time scale that is longer than the time needed for a vehicle to pass over the primary pads.

The configuration of FIGS. 11 and 11A enables decoupling of the voltage of the electrochemical capacitor from the battery voltage and the voltage at the DC link, i.e., the output voltage of the bridge rectifier. The bidirectional DC-DC converter enables active control of the charging and discharging of the power stored in the electrochemical capacitor.

In this configuration, the nominal voltage across the electrochemical capacitor can be higher than the nominal voltage across the battery so that the electrochemical capacitor can be recharged during a boost mode operation, the electrochemical capacitor can be discharged during a buck mode operation. In one embodiment, if the nominal voltage across the electrochemical capacitor is selected to be less than the nominal voltage of the battery, the bidirectional DC-DC converter can be reversed. In this case, a buck mode of operation (voltage step-down) is employed to convert the voltage from DC link to the voltage across the electrochemical capacitor, and a boost mode operation (voltage step-up) can be employed to convert the voltage from the electrochemical capacitor to the voltage applied across the DC link.

The bidirectional DC-DC converter can include two switching devices (T₁ and T₂) including their respective internal diodes and a converter inductor L_{C}. From the DC link to the electrochemical capacitor, inductor L_{C}, switch T₂, and diode D₂ form a boost converter that charges the electrochemical capacitor from the DC link. When an electric vehicle starts passing over transmit coils, a power flow is sensed at the DC link at the rectifier output. In the boost mode operation, power transfer triggers the controller so that T₁ is operated in a pulse width modulation (PWM) mode (i.e., continuously switched on and off at a duty cycle d) while T₂ is kept turned off. When T₁ is turned on, the L_{C} inductor is energized by the DC link voltage (i.e., while shorting DC link with respect to L_{C} through T₁). When T₁ is turned off, both the energized L_{C} inductor and the DC link supply power to the electrochemical capacitor through the diode D₂.

Once the electric vehicle moves away from the transmit coils, a relatively slow process of recharging the vehicle battery commences, which transfers the energy stored in the electrochemical capacitor to the vehicle battery. This time, the converter is operated in the buck mode operation. In this case, T₂, D₁, and L_{C}, form a buck converter from the electrochemical capacitor to the DC link, which is directly connected the vehicle battery terminals. In the buck mode operation, T₁ is kept off all the time, and T₂ is operated in a pulse width modulation (PWM) mode (i.e., continuously switched on and off at a duty cycle d*). When T₂ is turned on, the electrochemical capacitor discharges to the DC link while energizing the L_{C} (so that the voltage drop occurs across the converter inductor L_{C}. When T₂ is turned off, the electrochemical capacitor does not supply power to the DC link, but stored energy in the previously energized inductors keeps delivering power to the DC link until the stored power is depeleted. This allows discharging the electrochemical capacitor and recharging the vehicle battery in the buck mode operation. In one embodiment, upper and lower limits for the voltage across the electrochemical capacitor, i.e., U_{EC}_{_{—}}ₘₐₓ and U_{EC}_{_{—}}ₘᵢₙ, can be set to ensure safe and efficient operation of the converter. The electrochemical capacitor can be charged up to the maximum voltage U_{EC}_{_{—}}ₘₐₓ and can be discharged down to the minimum voltage U_{EC}_{_{—}}ₘᵢₙ. The bidirectional buck/boost DC-DC converter ensures that the vehicle battery is smoothly recharged instead of receiving high power pulses as the vehicle moves over the transmit coils.

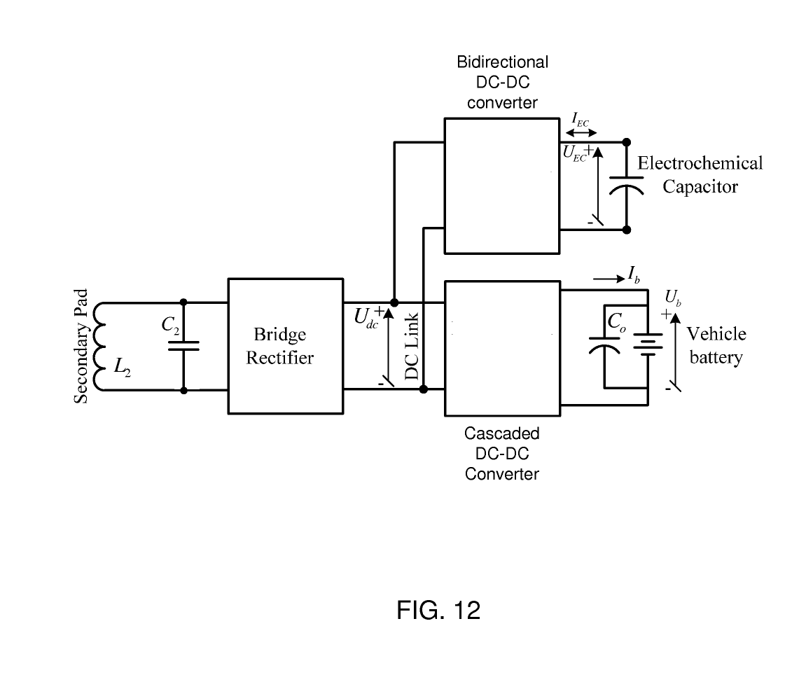

Referring to FIG. 12, a fourth exemplary receiver circuit is shown in which two separate DC-DC converters are employed. A bidirectional DC-DC converter can be connected in the same manner as in the receiver circuit of FIG. 11. Another DC-DC converter is cascaded between the DC link and the vehicle battery, i.e., between nodes of the output voltage of the rectifier circuit and nodes of the vehicle battery. This DC-DC converter can be a unidirectional DC-DC converter, and is employed to reduce voltage ripples across the vehicle battery. The input nodes of the DC-DC converter are connected directly to the DC link, and the output nodes of the DC-DC converter are connected directly to the vehicle battery. The combination of the first and second bidirectional DC-DC converters provides maximized flexibility in controls and active energy management among the storage devices.

### EXAMPLE

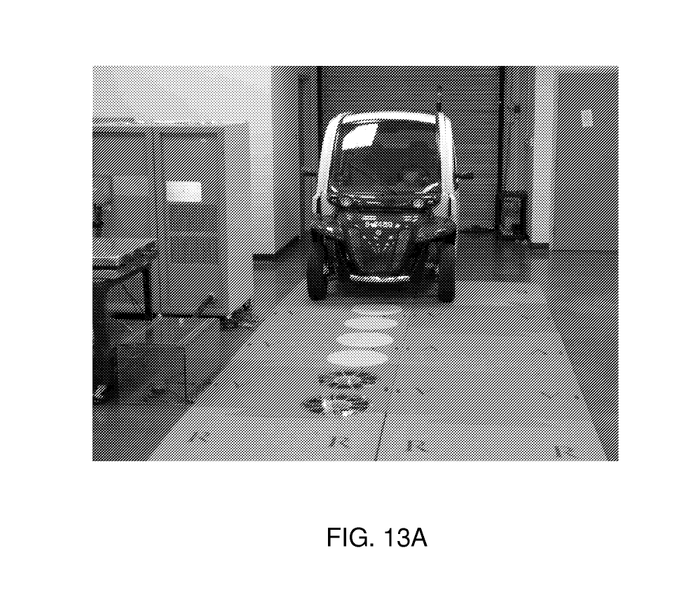

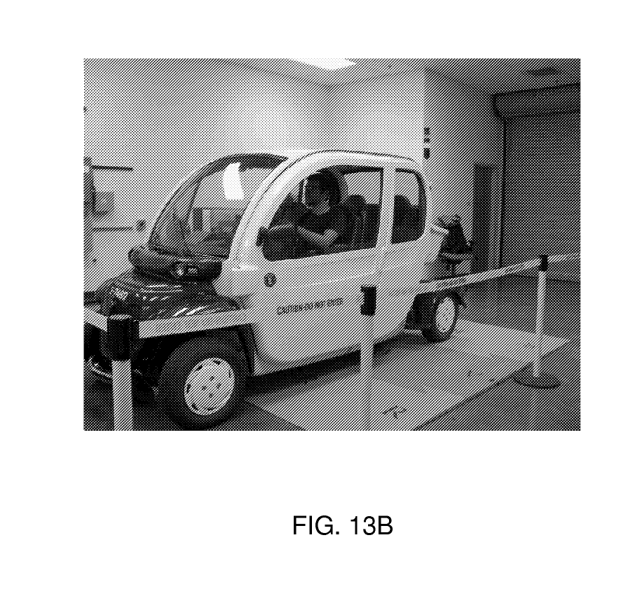

Referring to FIGS. 13A and 13B, a laboratory setup of an in-motion wireless power transfer system is shown, which includes six transmit pads arranged such that neighboring transmit pads are spaced by an equal distance. An electric vehicle passing over the transmit pads is also shown. A transmitter circuit embodying the first exemplary transmitter circuit of FIGS. 5 and 5A were switchably installed into the primary circuit of the setup. A receiver circuit embodying the third exemplary receiver circuit of FIGS. 11 and 11A were switchably installed into the secondary circuit (receiver circuit) of the vehicle.

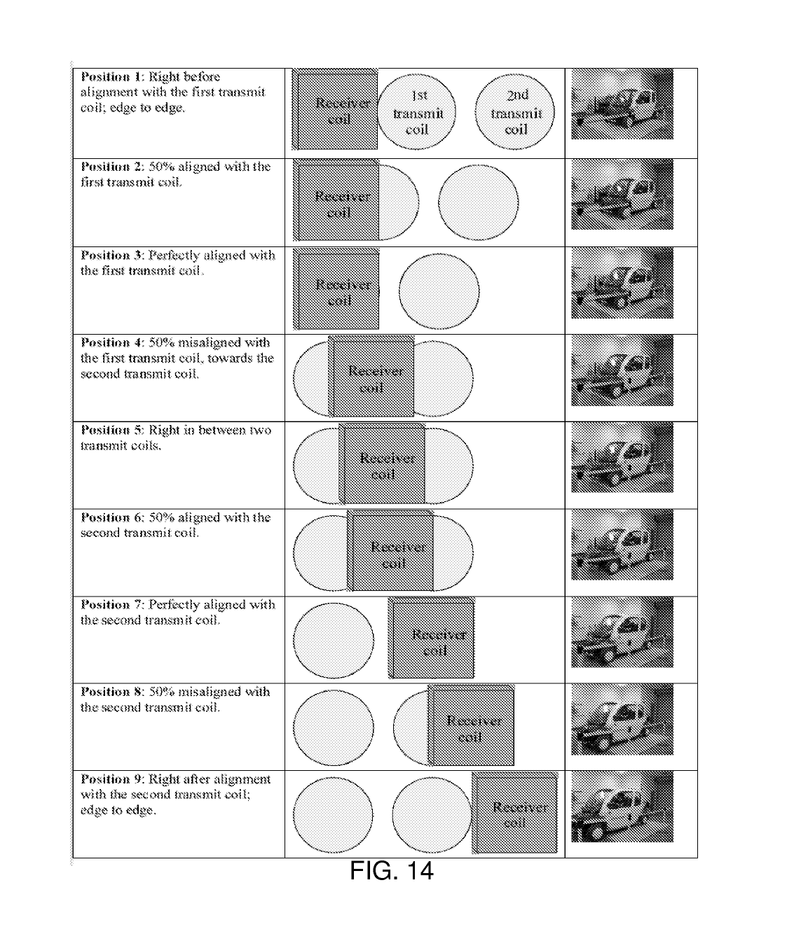

Referring to FIG. 14, a tabulated diagram illustrates relative positions of the receiver coil with respect to first two of the six transmit coils during the first nine positions at which measurements were taken. In this setup, each pad diameter is D, center to center spacing between the coils is L, and the pitch is D/L. With respect to these positions, primary and secondary side power data is collected and plotted for two cases with, and without, the aid of electrochemical capacitors utilized as energy buffers.

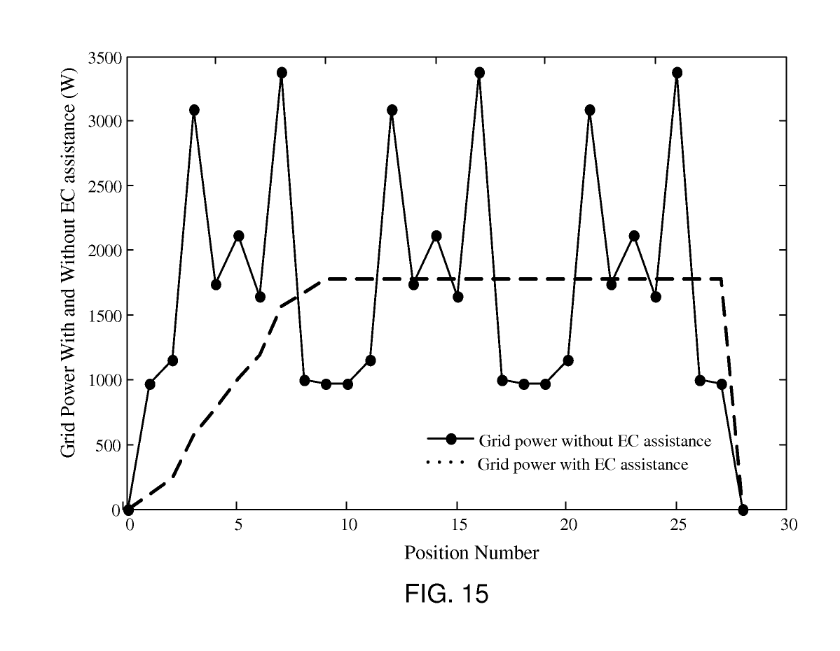

Referring to FIG. 15, the power delivered from the power grid to the vehicle battery is shown in a graph as a function of the position during in-motion wireless power transfer, i.e., with respect to the positions as the vehicle is passed through the transmit pads. Without the utilization of the electrochemical capacitor on the primary side, the grid is more stressed and grid power has large dips and current ripples. However, when the electrochemical capacitor on the transmitter circuit was utilized, much smoother power variations were reflected to the power grid. All the grid power ripples and transients are eliminated when the electrochemical capacitor was utilized as an energy buffer on the grid side.

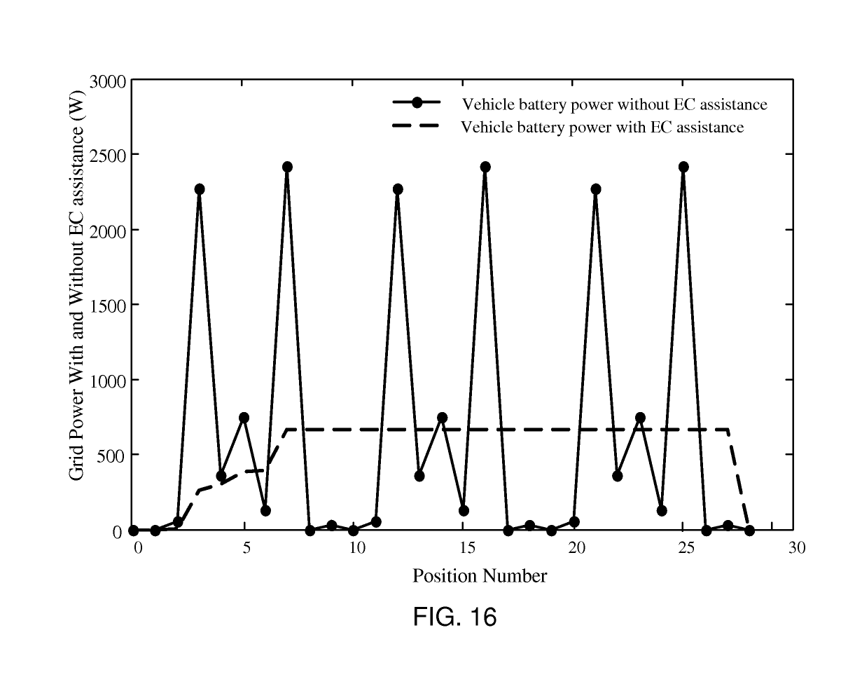

Referring to FIG. 16, the power received by the vehicle battery is shown as a function of the position during in-motion wireless power transfer, i.e., with respect to the positions as the vehicle is passed through the transmit pads. Use of the electrochemical capacitor on the receiver circuit also provided a positive effect on battery power variations. Similar to the grid power variations, ripples and dips in vehicle battery power can also be eliminated employing the electrochemical capacitor provided on the receiver circuit. With the proper utilization of the electrochemical capacitor, vehicle battery is only subject to the much smoother average power variations because the electrochemical capacitor energy storage system absorbs the voltage ripples and high power variations present at the receiver coil.

While the invention has been described in terms of specific embodiments, it is evident in view of the foregoing description that numerous alternatives, modifications and variations will be apparent to those skilled in the art. Each of the embodiments described herein can be implemented individually or in combination with any other embodiment unless expressly stated otherwise or clearly incompatible. Other suitable modifications and adaptations of a variety of conditions and parameters normally encountered in image processing, obvious to those skilled in the art, are within the scope of this invention. All publications, patents, and patent applications cited herein are incorporated by reference in their entirety for all purposes to the same extent as if each individual publication, patent, or patent application were specifically and individually indicated to be so incorporated by reference. Accordingly, the invention is intended to encompass all such alternatives, modifications and variations which fall within the scope and spirit of the invention and the following claims.

What is claimed is:

1. A receiver circuit for wireless power transfer comprising:
a receiver coil and a receiver capacitor connected to said receiver coil;
a rectifier circuit configured to receive a voltage across said receiver capacitor as an input and to generate an output voltage including a direct current component and an alternating current (AC) ripple component;
an electrochemical capacitor directly or indirectly connected to said output voltage; and
a vehicle battery directly or indirectly connected to said output voltage.

2. The receiver circuit of claim 1, further comprising a bidirectional DC-DC converter connected between nodes of said output voltage of said rectifier circuit and nodes of said electrochemical capacitor.

3. The receiver circuit of claim 2, wherein a combination of said bidirectional DC-DC converter and said electrochemical capacitor is in parallel connection with said vehicle battery with respect to an output of said rectifier circuit.

4. The receiver circuit of claim 3, wherein said bidirectional DC-DC converter is a bidirectional buck-boost converter.

5. The receiver circuit of claim 2, further comprising a DC-DC converter connected between nodes of said output voltage of said rectifier circuit and nodes of said vehicle battery.

6. The receiver circuit of claim 1, further comprising a cascaded DC-DC converter having input nodes that are directly connected across said electrochemical capacitor and output nodes that are directly connected across nodes of said vehicle battery, wherein said electrochemical capacitor is connected directly to said output voltage.

7. The receiver circuit of claim 1, further comprising:
a first cascaded DC-DC converter having input nodes that are directly connected across output nodes of said rectifier circuit and output nodes that are directly connected across nodes of said electrochemical capacitor; and
a second cascaded DC-DC converter having input nodes that are directly connected across said electrochemical capacitor and output nodes that are directly connected across nodes of said vehicle battery.

8. A method of operating a receiver circuit for wireless power transfer in an electric vehicle, said method comprising:
providing a vehicle equipped with a receiver circuit of claim 1;
causing said vehicle to pass over a track of transmit pads including transmit coils and storing energy received from said transmit coils through wireless power transfer in said electrochemical capacitor; and
transferring energy stored in said electrochemical capacitor into said vehicle battery after said vehicle exits a region overlying said track of transmit pads.

9. The method of claim 8, wherein said receiver circuit further comprises a bidirectional DC-DC converter connected between nodes of said output voltage of said rectifier circuit and nodes of said electrochemical capacitor, and said method further comprises:
transferring energy from said rectifier circuit through said bidirectional DC-DC converter into said electrochemical capacitor while said vehicle passes over said track of transmit pads; and
transferring energy from said electrochemical capacitor through said bidirectional DC-DC converter into said vehicle battery after said vehicle exits said region overlying said track of transmit pads.

10. The method of claim 8, wherein said receiver circuit further comprises a cascaded DC-DC converter having input nodes that are directly connected across said electrochemical capacitor and output nodes that are directly connected across nodes of said vehicle battery, and said electrochemical capacitor is connected directly to said output voltage, and said method further comprises:
storing energy from said wireless power transfer into said electrochemical capacitor while said vehicle passes over said track of transmit pads; and
transferring energy from said electrochemical capacitor through said cascaded DC-DC converter into said vehicle battery after said vehicle exits said region overlying said track of transmit pads.

11. A transmitter circuit for wireless power transfer comprising:
an active front end (AFE) unit including input nodes configured to be connected to alternating current (AC) power from a power grid and output nodes configured to provide a unipolar output voltage;
a high frequency inverter configured to convert said unipolar output voltage or a direct current (DC) voltage derived from said unipolar output voltage into an AC output voltage in a frequency range from 1 kHz to 1 MHz;
at least one set of a primary coil and a primary capacitor connected to said high frequency inverter; and
an electrochemical capacitor connected to nodes between said power grid and said high frequency inverter.

12. The transmitter circuit of claim 11, further comprising a bidirectional rectifier/inverter including first nodes connected directly to said input nodes of said AFE unit and second nodes connected directly across nodes of said electrochemical capacitor.

13. The transmitter circuit of claim 12, wherein said bidirectional rectifier/inverter is configured to operate as a rectifier employing said first nodes as input nodes and employing said first nodes as output nodes while said at least one set is not loaded with electrical current.

14. The transmitter circuit of claim 12, wherein said bidirectional rectifier/inverter is configured to operate as an inverter employing said second nodes as input nodes and employing said first nodes as output nodes while said at least one set is loaded with electrical current.

15. The transmitter circuit of claim 11, further comprising a bidirectional DC-DC converter including first nodes connected directly to nodes providing said unipolar output voltage and including second nodes connected directly across nodes of said electrochemical capacitor.

16. The transmitter circuit of claim 11, wherein said electrochemical capacitor is connected directly across nodes providing said unipolar output voltage.

17. The transmitter circuit of claim 11, further comprising a DC-DC converter including input nodes that are connected directly across nodes providing said unipolar output voltage and directly across said electrochemical capacitor, and including output nodes that are connected directly to said high frequency inverter.

18. A method of operating a transmitter circuit for wireless power transfer, said method comprising:
providing a transmitter circuit of claim 11, wherein said at least one primary coil is located within a track of at least one transmit pad;
storing energy in said electrochemical capacitor while said at least one primary coil does not perform wireless power transfer; and
transferring energy stored in said electrochemical capacitor into said high frequency inverter while wireless power transfer is performed from said at least one primary coil to an electric vehicle passing over said track of at least one transmit pad.

19. The method of claim 18, wherein said transmitter circuit further comprises a bidirectional rectifier/inverter including first nodes connected directly to said input nodes of said AFE unit and second nodes connected directly across nodes of said electrochemical capacitor, and said method further comprises:
operating said bidirectional rectifier/inverter as a rectifier employing said first nodes as input nodes and employing said first nodes as output nodes while said at least one primary coil does not perform wireless power transfer; and
operating said bidirectional rectifier/inverter as an inverter employing said second nodes as input nodes and employing said first nodes as output nodes while said at least one primary coil performs wireless power transfer.

20. The method of claim 8, wherein said transmitter circuit further comprises a DC-DC converter including input nodes that are connected directly across said electrochemical capacitor, and including output nodes that are connected directly to said high frequency inverter, and wherein said energy stored in said electrochemical capacitor is transferred into said high frequency inverter though said DC-DC converter.
